(19) United States
(12) Patent Application Publication
(10) Pub. No.: US 2011/0271794 A1
(43) Pub. Date: Nov. 10, 2011

(54) Hybrid electric vehicle generation system

(76) Inventor: Michael Hinds, Freeport, NY (US)

(21) Appl. No.: 13/068,155

(22) Filed: May 3, 2011

Related U.S. Application Data
(60) Provisional application No. 61/343,873, filed on May 5, 2010.

(51) Int. Cl. B60K 6/50; H02K 7/18; H02K 47/14; F16H 37/06; B60K 6/20; H02K 53/00

(52) U.S. Cl. 74/665 F; 290/1 R; 310/113; 74/DIG. 9; 180/65.25; 180/65.22; 903/905; 903/906; 903/907

(57) ABSTRACT

The present invention is directed to a generation means for generating electrical power to operate vehicle systems and/or for recharging batteries used by electric and/or hybrid cars. The present invention may also generate electric power to operate an electric motor that can also drive a vehicle. The present invention may also use the electric power generated for other uses as well. It comprises an engine that is connected to at least one rotatable member connected for rotation therewith and at least one generator that is connected to the rotatable member through a rotor in said generator to generate electrical energy.

This application claims priority on U.S. Provisional Application Ser. No. 61/343,873 filed on May 5, 2010, the disclosures of which are incorporated herein by reference.

### FIELD OF THE INVENTION

The present invention is directed to improvements in electric, hybrid and hydrocarbon fuel powered automobiles.

### BACKGROUND OF THE INVENTION

For over one hundred years automobiles have been powered by a variety of power generation systems. Initially, there were external combustion vehicles powered by steam followed by internal combustion vehicles powered by hydrocarbons there have also been vehicles powered by electricity, although until recently battery technology placed severe limitations on such vehicles. Recently there have been a variety of vehicles called hybrid electric vehicles, which combine a conventional propulsion system with an on board rechargeable system to achieve better fuel economy.

In internal combustion engines used in a variety of vehicles, the engine provides motive power from the engine to the wheels through, for example, a transmission and a drive train or through a transaxle. In each instance the engine power turns the wheels through a mechanical means. For the front wheeled drive cars, the engine turns the transaxle. For a rear wheel drive vehicles the engine turns a drive shaft which in turn causes the rear wheels to turn through the rear differential.

In the prior art, the vehicles would use the engine to generate electric power through a generator or a voltage regulator that is run off the engine by means of a drive belt. As the engine turns there is a belt, such as a serpentine belt, that is secured to gearing or pulleys on the engine which causes a drive gear of a generator or voltage regulator to turn thereby creating electricity that recharges a battery in the car. The automobile battery is used primarily to store electric power to run the electric starter motor that provides the initial “push” to rotate the crankshaft to get the internal combustion engine started. In addition to operating the starter motor, the battery provides electrical power to run the accessories such as lights, horn and radio.

As the engine turns in the prior art vehicles, the generator or alternator generates electrical power. The alternator or generator is driven by a belt or gearing. Rotary motion of the engine is transmitted to the generator or alternator where the commutator is rotated causing electric power to be generated.

U.S. Pat. No. 7,675,187 to Woods, et al., entitled “Power Generation Systems and Methods of Generating Power,” discloses a power generation system that includes an internal combustion engine configured to provide rotational mechanical energy. It also includes a generator that is configured to receive the rotational mechanical energy and generate electrical power in response to that energy. A fluid medium is also provided to the internal combustion engine and to the generator for removing thermal energy from the internal combustion engine and from the generator.

Storm, et al., U.S. Pat. No. 7,915,748 for an “AC electrical generation system,” is directed towards an AC electrical generator system for coupling a variable speed rotating power source to an AC electrical generator through a continuously variable transmission that has a finite variable transmission ratio. A controller controls the continuously variable transmission to transform rotational energy from the variable speed power source into substantially constant speed rotation of the AC electrical generator to produce AC electricity with frequency variations within an acceptable range.

Reddy, et al., U.S. Patent Application Pub. No. 2010/0065356 for “Electric Powertrain for Off-Highway Trucks,” discloses an engine that is configured to provide an off-highway truck with mechanical energy and that is coupled to at least one electric power generator is and that is adapted to convert at least a portion of the mechanical energy provided by the engine into electric energy. At least one electric motor is also operably coupled to the electric power generator.

Tsukada, et al., U.S. Pat. No. 7,255,188 for a “Hybrid Vehicle,” relates to a hybrid vehicle that comprises an internal combustion engine, a power transmission means for transmitting power from the engine to a drive wheel, a drive shaft connected to a driven side of the power transmission means that is also connected to the drive wheel, an electric motor connected to the drive shaft, and a unidirectional power transmission means provided between the power transmission means and the drive shaft that is capable of transmitting power in one direction from the power transmission means to the drive shaft. The electric motor also functions as an electrical generator for recharging the vehicle battery when rotation of the driven shaft is converted to electrical energy.

U.S. Pat. No. 7,892,128 to Schondorf, entitled “Hybrid Electric Vehicle and Powertrain,” teaches a hybrid electric vehicle and powertrain that includes an engine and an electric machine connected to each other in a power-split arrangement. The electric machine is operable as a motor or a generator. A power transfer arrangement includes a planetary gear set in which the carrier is directly connected to an output shaft of the engine. The electric machine is connected to the planetary gear set through an intermediate gear, thereby facilitating the offset of the electric machine and the engine and facilitating an easy change of gear ratio for the motor/generator.

Iida, et al., U.S. Pat. No. 7,367,414, is for a “Hybrid Vehicle and Method of Controlling the Same.” It teaches a power distribution integration mechanism that includes a carrier that is linked with the crankshaft of an engine, a sun gear that is linked with a motor MG1, and a ring gear that is linked with reduction gear via a ring gear shaft. The motor MG1 may function as an electric generator wherein the power output from the engine and transmitted through the carrier is distributed to the sun gear and the ring gear at their gear ratio.

Ishikawa, et al., U.S. Pat. No. 7,398,844 for a “Hybrid Vehicle,” discloses a hybrid vehicle that includes a motor generator MG1 that receives power of an engine via planetary gear to generate electrical power, and a motor generator MG2 that has a rotation shaft connected to planetary gear.

U.S. Pat. No. 7,694,773 to Janson, et al., for “Hybrid Electric Motor Vehicle and a Final Drive Unit therefor,” relates to a hybrid vehicle that has a motor/generator that is controlled by an electronic control unit and another motor/generator, both of which are driven by the vehicle's internal combustion engine to generate power. The motor/generators draw current from or supply current to a traction battery and to an auxiliaries battery.

U.S. Pat. No. 7,845,444 to Kidokoro, et al., entitled “Hybrid vehicle,” teaches a hybrid vehicle that has a transmission passage where an internal combustion engine has a crank shaft to which a rotor shaft of a generator is directly connected via a fly wheel.

Deng, et al., U.S. Pat. No. 7,690,456 for a “Power Generation System Suitable for Hybrid Electric Vehicles,” discloses FIG. 5 a power train system for a hybrid electric vehicle that includes an internal combustion engine, an electric motor, and an AC generator that may be connected by a split gear/power train.

U.S. Pat. No. 7,690,451 to Chiao for a “System and Method for Powering Accessories in a Vehicle,” teaches a system and method that comprises a main power unit having at least one power generating source that provides more than 42 volts of power to a high voltage DC power bus. The power generating source may comprise an internal combustion engine that is coupled to a generator through a drive shaft, a fuel cell, a micro-turbine or any other appropriate power source.

Langford, et al., U.S. Patent Application Pub. No. 2011/0017532, entitled “A Hybrid Powertrain,” relates to a hybrid powertrain comprising an electric motor, for driving a set of wheels of a vehicle, and energy storage means that is electrically connected to the electric motor for providing a supply of electric energy to the electric motor. The hybrid powertrain also comprises at least one micro turbine electrically connected to the energy storage means that is adapted to generate electrical energy for storing in the energy storage means.

U.S. Pat. No. 7,833,119 to Klemen, et al., for a “Powertrain with Series Electric Launch and Electric Power Assisted Performance,” discloses a powertrain that includes an engine with an engine output member, such as a crankshaft, and a first motor/generator having a first rotor connected to the crankshaft for rotation therewith.

### OBJECTS OF THE INVENTION

It is an object of the invention to provide one or more means for generating electric power from the engine of a vehicle.

It is also an object of the invention to provide one or more means for generating electric power from the motion of the vehicle.

It is a still another object of the invention to generate electricity from the motion of a vehicle to charge a battery.

It is a still further object of the invention to generate electricity from the internal combustion of an engine of a vehicle to operate an electric motor also present in the vehicle.

It is another object of the invention to provide a means for generating electric power that will reduce electric consumption from a hybrid car's or electric car's battery thereby providing longer intervals between recharging.

It is a still further object of the invention to provide a recharging means for recharging a vehicle battery.

It is a still further object of the invention to provide an electric power generation means that can recharge a battery in a hybrid vehicle from the motion of the vehicle.

### SUMMARY OF THE INVENTION

The present invention is directed to a generation means for generating electrical power to operate vehicle systems and/or for recharging batteries used by electric and/or hybrid cars. The present invention may also generate electric power to operate an electric motor that can also drive a vehicle. The present invention may also use the electric power generated for other uses as well.

The generation means of the present invention converts mechanical energy into electrical energy. In one embodiment, the electricity is generated by electromagnetic induction. The generator may have a structure which provides a constant magnetic field and a set of rotating windings which turn within that field. The constant magnetic field may be provided by one or more permanent magnets and/or one or more electromagnets or field coils.

An alternator may also be used as the generation means as well. The alternator is similar to a generator but produces AC current while the generator produces DC current. The alternator generates electricity when the magnetic field around a conductor changes. As the magnetic field around a conductor changes, a current is induced in the conductor. Typically, a rotating member called a rotor turns within a stationary set of conductors wound in coils on a core called a stator. The field cuts across the conductors generating electrical current as the mechanical input causes the rotor to turn. The rotating magnetic field induces an AC voltage in the stator windings.

The generation means of the present invention may be an in-line generation means whereby an internal combustion engine directly turns a rotatable member, such as the axle or the drive train. As the rotatable member rotates, it turns the commutator or rotor that is in-line with the rotatable member.

In an alternate embodiment, the rotatable member can have a gear or pulley thereon. The gear or pulley can rotate a gear or belt that, in turn, rotates the commutator or rotor. The generator or alternator can be driven by any one or more rotating members. For example, the generator or alternator may be connected to one or more of the axles of the vehicle so that as the wheels turn, the rotation of the axles causes the commutator or rotator to turn thereby generating DC or AC electric power from the rotation of the wheels. It will be appreciated that the wheels can be directly driven, such as by a rear differential or transaxle. Alternatively, the wheels can be indirectly driven, such as by the rotation of the front wheels on a rear wheel drive car or the rotation of the rear wheels on a front wheel drive car.

In an alternative embodiment, the alternator or generator can be driven by the drive shaft of the vehicle. In one embodiment, the alternator or generator may be in-line with the drive shaft. By in-line is meant that the center axis of the drive shaft and the center axis of the rotor or commutator are generally in the same plane. In this embodiment, there would be a length of drive shaft secured to one end of the rotor or commutator of the alternator or generator and another length of drive shaft secured to the other end of the rotor or commutator. The drive shafts may be secured to either end of the rotor or commutator by any suitable means. This in-line arrangement may be used by any of the means set forth herein.

In a second embodiment, the drive shaft is not in-line with the rotor or commutator of the electrical generating device. In this preferred embodiment there is a rotating member that is being driven by the engine. The engine can be an internal combustion engine or it can be an electric motor. The rotating member is provided with a gear in one embodiment. As the rotating member rotates the gear turns as well. The rotating member has a length and the cross section. The gear is around at least a portion of the rotating member. The gear and the rotating member are preferably concentric. As the rotating member turns the gear rotates as well. The gear is preferably a toothed gear that turns a toothed gear on the commutator or rotor of the electrical generating device. As the rotating member turns the first gear on the rotating member turns. The teeth mesh with the teeth of the second gear which is mounted on the rotor or the commutator. As the rotating member is driven by the electric motor or the internal combustion engine the first gear rotates and the teeth on the first gear rotate the teeth on the second gear thereby turning the rotor or commutation as the rotor or commutation is turned the motion causes electric current to be generated by the generating means. The generating means transfers the electric current to a battery or directly to the electric motor to thereby turn the electric motor.

The gear that is on the rotating member may be on any one of the axles present on the vehicle. Alternatively, the rotating member may be on the drive shaft or connected to the transaxle. In a still further embodiment, the gears may be between the transmission and the drive shaft. In a still further embodiment the gear can be secured to the gearing in the rear differential. As the engine turns the drive shaft also turns. A pinion gear at the end of the drive shaft is encased within the differential itself and it engages with a large ring gear. The ring gear is attached to a carrier which holds a set of three small planetary gears. The planetary gears are arranged that two outer gears can rotate in opposite directions relative to each other. The pair of side gears drive the axle shafts of each of the wheels. The entire carrier rotates in the same direction as the ring gear but within that motion the side gears can counter rotate relative to each other.

In an alternative embodiment of the present invention the differential itself may be provided with an additional opening that provides a gear on a generating means with access for example a ring gear of a rear differential. As the drive shaft rotates the ring gear, the ring gear also rotates the rotor or commutation on a generating means which in turn produces electric current for operating the electric motor or one or more accessories or for recharging the battery.

In a still further embodiment of the invention the generation means may be connected between the internal combustion engine and the transmission or transaxle for front wheel drive cars. For some front wheel drive cars, the transaxle is connected to a differential gear on the front axles. In these arrangements the generation means may be connected to the gearing of the differential gear as described above. Alternatively, the generation means may be positioned between the intermediate shaft and the differential or between the intermediate shaft and the transaxle. Similarly, for rear wheel drive vehicles the generation means may be positioned between the engine and the transmission as well as between the transmission and the drive train.

### BRIEF DESCRIPTION OF THE DRAWINGS

FIG. 1 shows an embodiment of the power generation means of the present invention wherein the generator is connected to a vehicle drive train.

FIG. 2 shows an alternate embodiment of the power generations means of the present invention wherein the generator is connected to a vehicle axle.

### DETAILED DESCRIPTION OF THE INVENTION

In one embodiment of the invention there is an engine and a transmission connected to the engine. The transmission is connected to a front drive shaft. There is a rear drive shaft that is connected to a rear differential. The rear differential provides power from the engine to the rear wheels. As the engine operates, the engine power is transmitted by the drive shaft through the rear differential to each wheel.

In accordance with the present invention the motive power of the engine can be used to turn a generator to generate electricity for use by the vehicle. This electrical power may operate accessories used in the vehicle such as radio, light, etc. or may be stored in a battery.

The generator can be positioned in any number of locations in the vehicle. In one embodiment the generator is between the engine and the transmission. In another embodiment the generator may be between the transmission and the front drive shaft and the rear drive shaft. The generator may also be driven by the rear differential. Either there may be a generator secured to either or both of the wheel axles or the generator may be extended from the rear differential itself. The instances just given are not the only locations. Other locations can include the front axles. As the front axles rotate by the power to the rear wheels.

The generation means of the present invention converts mechanical or rotational energy into electrical energy for use by the vehicle. In one embodiment, the electricity used by the vehicle is generated by electromagnetic induction. The generator may be designed to provide a constant magnetic field and a set of rotating windings which turn within that field. The constant magnetic field may be provided by one or more permanent magnets and/or one or more electromagnets or field coils.

In an alternate embodiment, the alternator may also be used as the generation means as well. The alternator produces AC current while the generator produces DC current. The alternator generates electricity when the magnetic field around a conductor changes. As the magnetic field around a conductor changes, a current is induced in the conductor. Typically, the rotating member of the alternator, i.e., a rotor turns within a stationary set of conductors wound in coils on the core, i.e., the stator. The field cuts across the conductors generating electrical current as the mechanical input causes the rotor to turn. The rotating magnetic field induces an AC voltage in the stator windings.

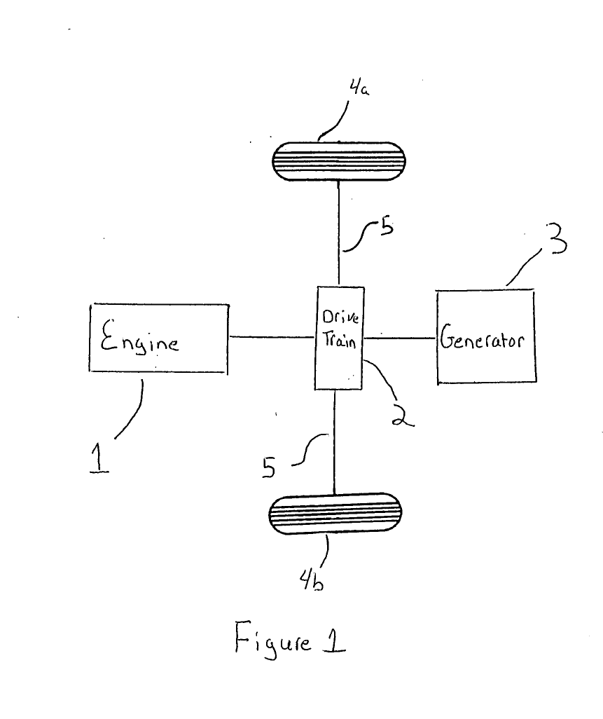

The generation means of the present invention may be an in-line generation means whereby a rotatable member is connected to an engine. The rotatable member may be an axle or the drive train that is turned by the engine. As the rotatable member rotates, it turns the commutator or rotor that is in-line with the rotatable member. FIG. 1 shows a schematic of the embodiment where the generator is connected to the vehicle drive train. It shows an engine 1, which may be an internal combustion engine or an electric motor, that is connected to a drive train 2. It also shows the drive train 2 as connected to a generator 3 that may have a rotor or commutator. In this embodiment, the engine 1 turns the drive train 2. As the drive train 2 rotates, it turns the generator 3 rotor or commutator that is in line with the drive train 2, thereby generating electricity. Also shown are vehicle wheels 4a and 4b that are connected to the drive train 2 through a vehicle axle.

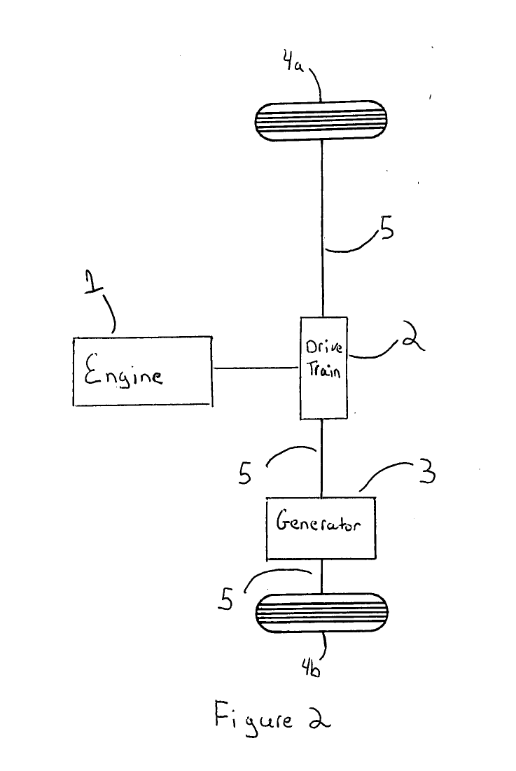

FIG. 2 illustrates an embodiment where the generator is connected to a vehicle axle. It shows an engine 1, which may either be an internal combustion engine or an electric motor, that is connected to a drive train 2. It also shows a vehicle axle 5 that is connected to the drive train 2 at one end and that is connected to vehicle wheels 4a and 4b at axle's 5 other end. Also shown is a vehicle generator 3 that is connected along a portion of the vehicle axle 5. In this embodiment, the engine 1 turns the drive train 2. As the drive train 2 rotates, it turns the vehicle axle 5 which in turn rotates the generator 3 rotor or commutator that is connected along at least a portion of the vehicle axle 5, thereby generating electricity. Also shown are vehicle wheels 4a and 4b that are connected to the drive train 2 through the vehicle axle.

In an alternate embodiment, the rotatable member can have a gear or pulley thereon. The gear or pulley can rotate a gear or belt that, in turn, rotates the commutator or rotor. The generator or alternator can be driven by any one or more rotating members. For example, the generator or alternator may be connected to the front or rear axles of the vehicle or both so that as the wheels turn, the rotation of the axles causes the commutator or rotator to turn thereby generating DC or AC electric power from the rotation of the wheels. It will be appreciated that the wheels can be directly driven, such as by a rear differential or transaxle. Alternatively, the wheels can be indirectly driven, such as by the rotation of the front wheels on a rear wheel drive car or the rotation of the rear wheels on a front wheel drive car. In either instance the rotation can generate electrical current.

In an alternative embodiment, the alternator or generator can be driven by the drive shaft of the vehicle. In one embodiment, the alternator or generator may be in-line with the drive shaft. By in-line is meant that the center axis of the drive shaft and the center axis of the rotor or commutator are generally in the same plane. In this embodiment, there would be a length of drive shaft secured to one end of the rotor or commutator of the alternator or generator and another length of drive shaft secured to the other end of the rotor or commutator. The drive shafts may be secured to either end of the rotor or commutator by any suitable means. This in-line arrangement may be used by any of the means set forth herein.

In a second embodiment, the drive shaft is not in-line with the electrical generating device. In this preferred embodiment there is a rotating member that is being driven by the engine. The engine can be an internal combustion engine or it can be an electric motor. The rotating member is provided with a gear in one embodiment. As the rotating member rotates the gear turns as well. The gear is preferably a toothed gear that turns a toothed gear on the commutator or rotor of the electrical generating device. As the rotating member turns the first gear on the rotating member turns. The teeth mesh with the teeth of the second gear which is mounted on the rotor or the commutator. As the rotating member is driven by the electric motor or the internal combustion engine the first gear rotates and the teeth on the first gear rotate the teeth on the second gear whereby the motion causes electric current to be generated by the generating means. The generating means transfers the electric current generated by the alternator or the generator to a battery or directly to the electric motor to thereby turn the electric motor and thus reduce the wasted energy of the internal combustion engine.

The gear that is on the rotating member may be on any one of the axles present on the vehicle. Alternatively, the rotating member may be on the drive shaft or connected to the transaxle. In a still further embodiment, the gears may be between the transmission and the drive shaft. In a still further embodiment the gear can be secured to the gearing in the rear differential. As the engine turns the drive shaft also turns. A pinion gear at the end of the drive shaft is encased within the differential itself and it engages with a large ring gear. The ring gear is attached to a carrier which holds a set of three small planetary gears. The planetary gears are arranged that two outer gears can rotate in opposite directions relative to each other. The pair of side gears drive the axle shafts of each of the wheels. The entire carrier rotates in the same direction as the ring gear but within that motion the side gears can counter rotate relative to each other.

In still a further alternative embodiment of the present invention the differential itself may be provided with an additional opening that provides a gear on a generating means with access for example a ring gear of a rear differential. As the drive shaft rotates the ring gear, the ring gear also rotates the rotor or commutation on a generating means which in turn produces electric current for operating the electric motor or one or more accessories or for recharging the battery.

In a still further embodiment of the invention the generation means may be connected between the internal combustion engine and the transmission or transaxle for front wheel drive cars. For some front wheel drive cars, the transaxle is connected to a differential gear on the front axles. In these arrangements the generation means may be connected to the gearing of the differential gear as described above. Alternatively, the generation means may be positioned between the intermediate shaft and the differential or between the intermediate shaft and the transaxle. Similarly, for rear wheel drive vehicles the generation means may be positioned between the engine and the transmission as well as between the transmission and the drive train.

I claim:

1. A hybrid electric vehicle generation system for generating electrical energy comprising:
an engine;
at least one rotatable member connected to said engine for rotation therewith; and
at least one generator connected to said rotatable member through a rotor in said generator.

2. The system according to claim 1 wherein said engine is an internal combustion engine.

3. The system according to claim 1 wherein said engine is an electric motor.

4. The system according to claim 1 wherein at least one of said generator may be an alternator.

5. The system according to claim 2 wherein said generation system is an in-line generation system.

6. The system according to claim 5 wherein said rotatable member is one or more vehicle axles.

7. The system according to claim 5 wherein said rotatable member is a vehicle drivetrain

8. The system according to claim 2 wherein said generation system is not in-line.

9. The system according to claim 8 wherein said rotatable member is connected to said generator motor through a first gear that is connected to at least a portion of said rotatable member and that is further connected to a second gear that is connected to at least a portion of said generator rotor.

10. The system according to claim 9 wherein said rotatable member is a vehicle drive shaft.

11. The system according to claim 9 wherein said rotatable member is one or more vehicle axles.

12. The system according to claim 9 wherein said rotatable member is a vehicle transaxle.

13. The system according to claim 10 wherein said first gear and said second gear are ring gears.

14. The system according to claim 3 wherein the electricity generated is used to operate said electric motor, to operate one or more vehicle accessories, and to recharge a vehicle battery.

15. The system according to claim 1 wherein said rotatable member is a gear that is connected to a vehicle differential that is connected to said engine, wherein said differential gear is connected to a gear on said generator rotor for rotation therewith.

16. The system according to claim 1 wherein said generation system converts mechanical or rotational energy from said engine into electrical energy.

17. The system according to claim 1 wherein said electrical energy is generated by electromagnetic induction.

18. A hybrid electric vehicle generation system for generating electrical energy comprising:
an internal combustion engine;
at least one rotatable member connected to said engine, wherein said rotatable member is a vehicle front axle; and
at least one generator connected to said axle through a rotor in said generator, wherein at least a portion of said generator rotor is connected to a ring gear that is connected to a second ring gear, wherein the second ring gear is connected to at least a portion of said front axle.
